(19) United States
(12) Patent Application Publication
(10) Pub. No.: US 2014/0164615 A1
(43) Pub. Date: Jun. 12, 2014

(54) SYSTEMS AND METHODS FOR ENTERPRISE CLOUD MULTI-SITE APPLICATION TARGETING

(71) Applicants: Mark Bonnell, Vitacura (CL); Pablo Córdova, Las Condes (CL); José Antonio Silva, Providencia (CL); Felipe Rojas, Nunoa (CL); Roberto Rivera, Vitacura (CL)

(72) Inventors: Mark Bonnell, Vitacura (CL); Pablo Córdova, Las Condes (CL); José Antonio Silva, Providencia (CL); Felipe Rojas, Nunoa (CL); Roberto Rivera, Vitacura (CL)

(21) Appl. No.: 13/932,923

(22) Filed: Jul. 1, 2013

Related U.S. Application Data
(60) Provisional application No. 61/666,681, filed on Jun. 29, 2012.

(51) Int. Cl. H04L 29/08

(52) U.S. Cl. CPC H04L 67/16
USPC 709/225

(57) ABSTRACT

The systems and methods of the present disclosure provide the capacity to create via a web browser a cluster of integrated web sites, mobile sites, and applications by an organization in its own private cloud where applications, web sites, mobile sites and users can be matched through a consumer targeting engine based on dynamic filters with relevant content and applications in real time across the cluster of web sites and mobile sites. In an embodiment, the systems and methods of the present disclosure provide the capacity to define via a web browser the unique data conditions that will match applications with target users via a web site or mobile site. User data collected from online data forms is matched with user data collected from interactions within the web site to produce dynamic targets. Dynamic targets form the foundation of the targeting engine for matching relevant content and applications to specific audiences within a web site or cluster of web sites.

This application claims priority to U.S. Provisional Patent Application No. 61/666,681 filed Jun. 29, 2012, the entire disclosure of which, including the appendices thereto, is incorporated herein by reference.

### FIELD OF THE TECHNOLOGY

At least some embodiments disclosed herein relate generally to facilitating the targeting of software as a service applications to specific global audiences in real time by large multinational organizations through their digital platforms that manage multiple web sites and mobile sites. More specifically, in various embodiments the invention relates to systems and methods for allowing large companies to configure and deploy multiple integrated web sites and mobile sites with applications that are served in real time by specifying which target consumers qualify to interact with specific applications in real time across multiple integrated web sites.

### BACKGROUND

Multinational organizations produce web sites and mobile sites each month in an attempt to interact with target audiences both internal to the organization and external to the organization. These web sites contain content and applications for target audiences and segments of the population. In many cases, web site registration data is captured from these web sites from digital audiences. Often times each web site by the same multinational organization is produced independently by country, by region, by brand or by business unit.

Typically, multinational organizations produce web sites or mobile sites in a custom manner programming in-house with employees or contracted developers. In other cases, organizations have bought web content management systems (CMS') that produce web sites whereby they customize the web content management system for the web site. In other cases, multinational organizations have externalized the development of web sites and mobile applications to digital agencies or to information technology service providers such as IBM or others.

### SUMMARY

In an embodiment, the systems and methods of the present disclosure provide the capacity to create via a web browser a cluster of integrated web sites, mobile sites, and applications by an organization in its own private cloud where applications, web sites, mobile sites and users can be matched through a consumer targeting engine based on dynamic filters with relevant content and applications in real time across the cluster of web sites and mobile sites.

In an embodiment, the systems and methods of the present disclosure provide the capacity to define via a web browser the unique data conditions that will match applications with target users via a web site or mobile site. User data collected from online data forms is matched with user data collected from interactions within the web site to produce dynamic targets. Dynamic targets form the foundation of the targeting engine for matching relevant content and applications to specific audiences within a web site or cluster of web sites.

### BRIEF DESCRIPTION OF THE DRAWINGS

The embodiments are illustrated by way of example and not limitation in the figures of the accompanying drawings in which like references indicate similar elements.

FIG. 1 illustrates an embodiment of an account structure supported by at least one embodiment of the disclosed systems and methods.

FIG. 2 illustrates an embodiment of an application structure supported by at least one embodiment of the disclosed systems and methods.

FIG. 3 illustrates an embodiment of an integration of at least one embodiment of the disclosed systems and methods with third party websites, such as social networking websites.

FIG. 4 illustrates an embodiment of a user interface whereby a user logs into a platform provided by at least one embodiment of the disclosed systems and methods.

FIG. 5 illustrates an embodiment of a user interface whereby a user creates a new site within a platform provided by at least one embodiment of the disclosed systems and methods.

FIG. 6 illustrates an embodiment of a user interface for defining initial target restrictions within a platform provided by at least one embodiment of the disclosed systems and methods.

FIG. 6 illustrates an embodiment of a user interface for defining initial target restrictions within a platform provided by at least one embodiment of the disclosed systems and methods.

FIGS. 7A and B illustrate an embodiment of a user interface for defining a target at a site level within a platform provided by at least one embodiment of the disclosed systems and methods.

FIG. 8 illustrates an embodiment of a user interface for a user interface for applying a filter to a target within a platform provided by at least one embodiment of the disclosed systems and methods.

FIG. 9 illustrates an embodiment of a user interface showing a summary of the users that match the target criteria that are grouped into a target within a platform provided by at least one embodiment of the disclosed systems and methods.

FIG. 10 illustrates an embodiment of a user interface illustrating that a targeting process can be repeated without restriction identifying matches to the target at any time within a platform provided by at least one embodiment of the disclosed systems and methods.

FIG. 11 illustrates an embodiment of a user interface that allows a user to select applications for targeting via a pull-down menu within a platform provided by at least one embodiment of the disclosed systems and methods.

FIG. 12 illustrates an embodiment of a user interface that provides a network application within a platform provided by at least one embodiment of the disclosed systems and methods.

FIG. 13 illustrates an embodiment of a user interface that that enables a user to specify targeting options for an application within a platform provided by at least one embodiment of the disclosed systems and methods.

FIGS. 14A and B illustrate an embodiment of a user interface that enables a user to create data forms that can be presented to targets to gather additional data about such targets within a platform provided by at least one embodiment of the disclosed systems and methods.

FIGS. 15A and B illustrate an embodiment of a user interface that enables creation of a leads campaign within a platform provided by at least one embodiment of the disclosed systems and methods.

### DETAILED DESCRIPTION

The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

### An Illustrative System Architecture

In an embodiment, the systems and methods of the present disclosure are provided, at least in part, via a platform hereinafter referred to as “the platform”, hosted, at least in part, in a commercial cloud-computing environment. In various embodiments, the platform can provide various services that can include, but are not limited to, the services described immediately below.

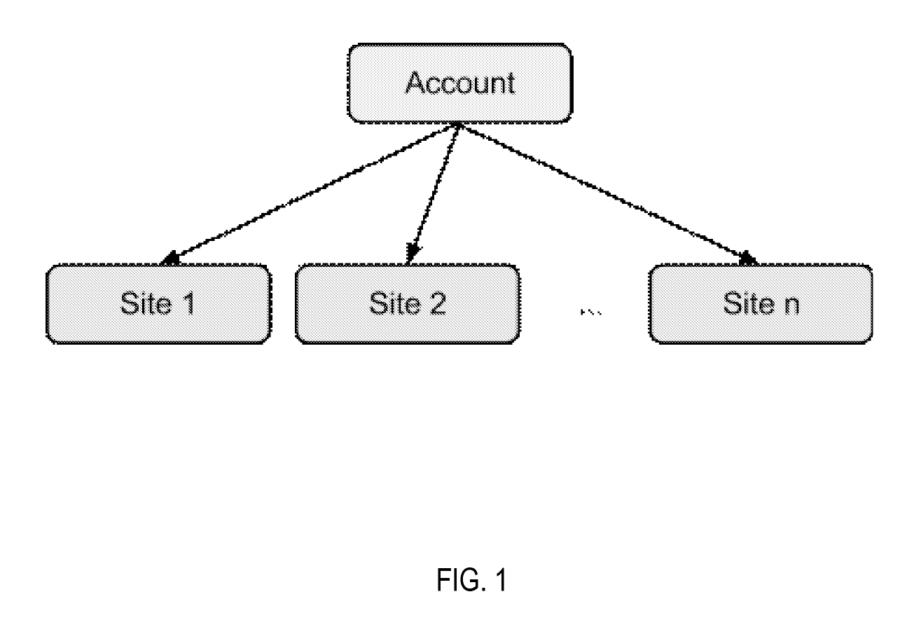

In an embodiment, the platform provides services that allow organizations to dynamically define a cluster of integrated web sites, mobile sites, and applications that reside in a private, organization-specific cloud computing environment that the platform defines and maintains within a commercial cloud computing environment In an embodiment, the platform supports the definition of accounts. For the purposes of the present disclosure, the term “account” should be understood to refer to the highest-level data unit on supported by the platform. In an embodiment, an account represents an organization and all data within the platform is connected in some way to a specific account. In various embodiments:
Each account has its own subdomain.
No data is shared between accounts.
One or more sites (e.g. websites and/or mobile sites) can be created under an account as shown in FIG. 1.
Each site consists of two major parts: a front end and a back end. A front end is intended to provide a customizable user web and mobile interface for the organization audience interactions. The backend is used for the organization administrators and operators.
Each site refers to a unique URL that can be customizable by the organization.

In an embodiment, the platform supports users and roles. Platform roles can include:
Administrator or owner.
Agent or community manager.
Designer or developer.
End user.
Any user can have more than one role.

In an embodiment, the platform provides support for user profiles. In an embodiment, each registered user there is a backend profile in which an admin or agent can see interactions and detailed information. For each user, if the site has enabled their social network capabilities, there is a public profile for share the user activity with other members of the community.

In an embodiment, the platform provide capabilities whereby data collected from users in one web site, enables the entire cluster of web sites to recognize the user and not request the same data if interacting or registering in another web site, avoiding duplicate user data across the entire cloud or private cluster of web sites and mobile sites.

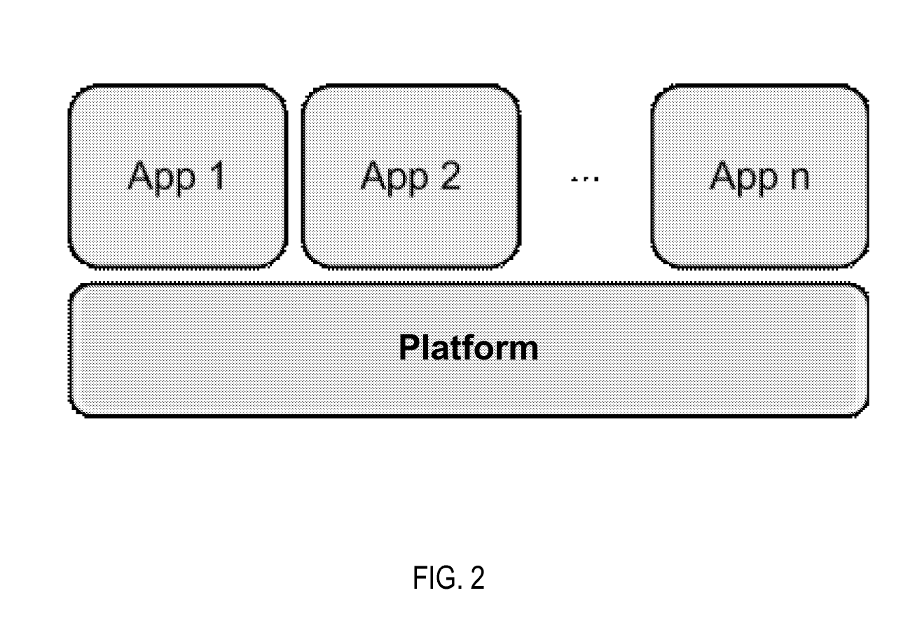

In an embodiment, the platform provides support for applications as shown in FIG. 2. In various embodiments, applications are groups of functionality designed to provide ways to interact and communicate with end users. In an embodiment, different sites can use a different set of applications for different purposes. In an embodiment, the platform provides the ecosystem in which each application can extend the platform functionality adding things like widgets, filters, layouts, language, settings, asset types, mailings and views.

In an embodiment, the platform provides services that allow organizations to dynamically target their sites and applications to specific “targets”. For the purposes of the present disclosure, the term “target” should be understood to refer to a cluster of people that match certain variables defined by each organization independently in the organization's cloud of sites (e.g. users having specific user profile data attributes). Once targets have been created, sites, applications and content deployed in an organization's cloud can be distributed and made available to specific targets in real time.

In an embodiment, a target is a combination of filters intended to classify a large amount of user data. Each filter is designed with a specific purpose and the combination of them can provide very specific segments of user data. In an embodiment, any resource or tools defined on the platform can restrict its scope to targets giving the flexibility to work with small or large groups of people who share a common target. In an embodiment, targets are calculated in real time. In an embodiment, third party applications can define their own targets through an API provided by the platform. In an embodiment, a target can be promoted to a qualified target when someone does something in the system such as buying or filling out a specific form or interacting with a specific application.

In an embodiment, the systems and methods of the present disclosure provide data forms that are created via a browser can be targeted to specific targets. For example, a target has been defined from previous data form and user interaction data. Users that are female between the ages of 18-24 years old that have commented 5 times in the web site will be asked one question the next time that they log in and identify themselves in the web site. Users that match this target will have the specific data form application that matches their criteria appear at login. Data collected via such forms can be further used to further refine targeting of targets, creating dynamic targets.

In an embodiment, the platform provides support for resources and interactions. An interaction can be any type of action by a user. A resource is where any interaction takes place giving context to the interactions (e.g. a question on a topic, a review in a product, a comment in a video).

For example, in an embodiment, the platform provides an application for capturing questions or ideas from specific target users will appear to specific target users only. For example, a target that is created dynamically from a data form answer specifies that the user is a client that works in the marketing industry. Users that match the target client and marketing industry will receive interaction access to the support application for capturing questions and ideas. All other users that do not match the target are excluded from interactions with the application.

In another embodiment, the platform can provide one or more applications for capturing user media such as pictures, videos, text, audio files or other user media will appear to specific target users. The number of interactions with the application by a single user may be controlled as well as the types of interactions permitted with the application. The user may vote, provide an opinion, or comment on the media. The user media application may be targeted to specific audiences using the dynamic targeting previously described.

In an embodiment, the platform provides a real-time dashboard to all users of the system. In an embodiment, the dashboard provides users with information about the users' registration status and the current database gender and age composition. In an embodiment, the time frame of the dashboard defaults to 30 days but can be customized to refer to a longer or shorter periods of time. In an embodiment, each graph in the dashboard allows to drill down the data in order to get more specific information.

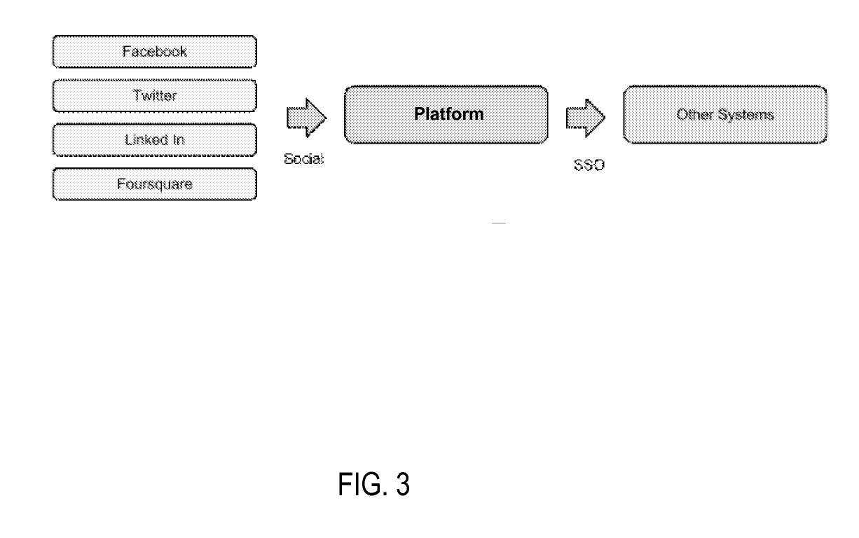

In an embodiment, the platform can provide a social single sign on system. In an embodiment, the social single sign on system allow organizations to use their own user database to authenticate users through different sites inside within the platform or outside the platform using an Oauth API implementation. For the purposes of the present disclosure, the term “social” should be understood to refer to the capacity to create users connecting user's social network accounts. For example, the platform could provide support for FACEBOOK, TWITTER, LINKEDIN and FOURSQUARE as shown in FIG. 3.

In an embodiment, the systems and methods of the present disclosure provide a unique URL can be generated to track the acquisition of people from a third party web site directly to a matched target to understand which advertising, messages or links produce the acquisition of people directly matched to the target. The click on the link with unique parameters is connected exactly to the target inside the cloud so as to know which link produced which target and as a result make available certain applications based on the acquisition source.

### An Illustrative User Interface

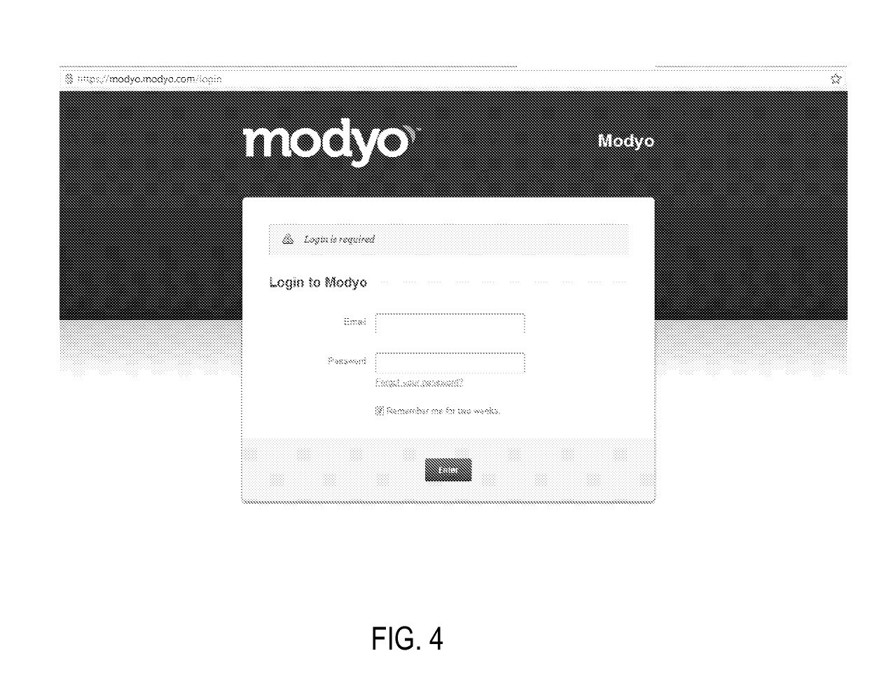

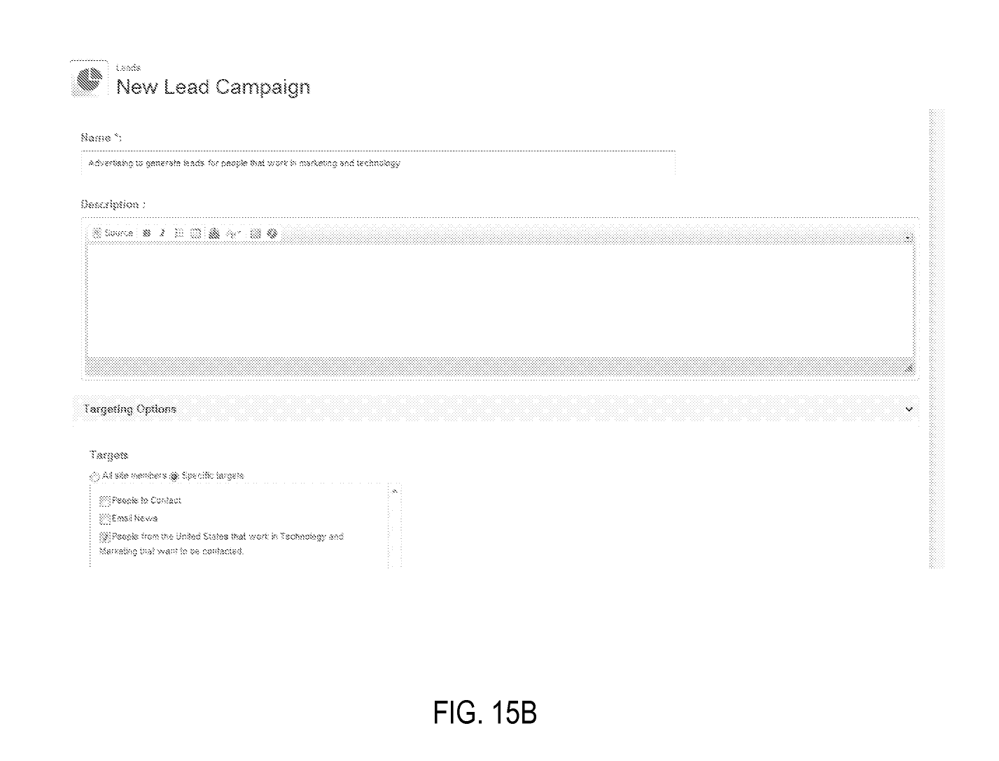

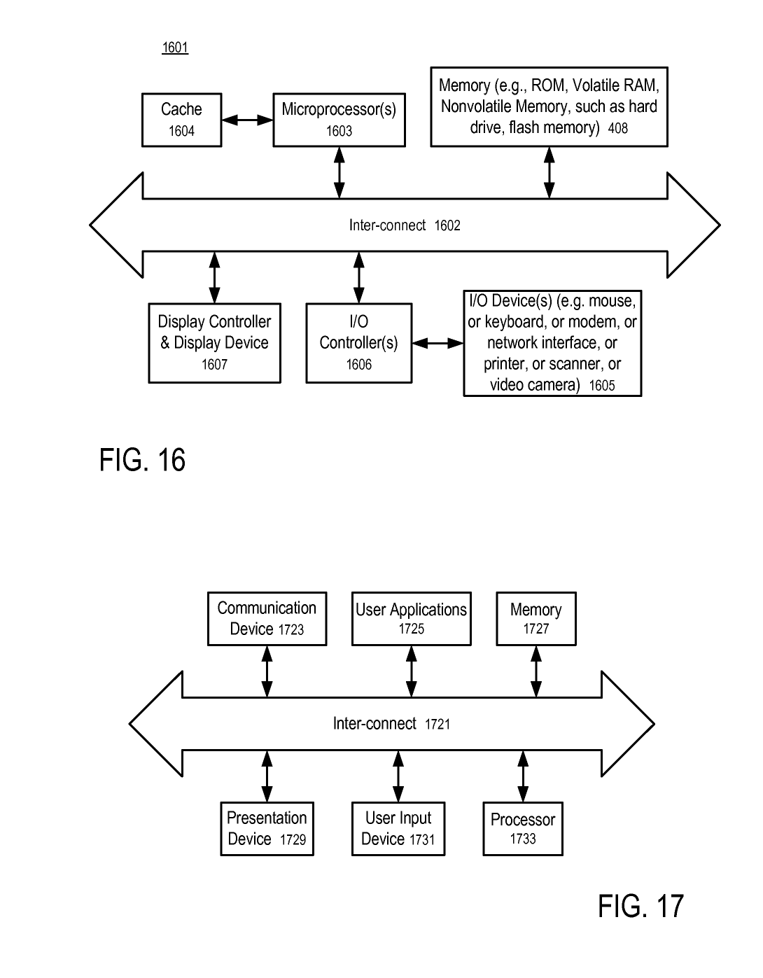

In an embodiment, users, both end users and various other technical and administrative interact with the platform via a web-based user interface provided by the platform. FIG. 4 though FIG. 15 illustrate various aspects of an exemplary user interface provided by the platform. Further discussions of other user interface elements and functions that can be provided by the platform are disclosed in Appendices A and B, attached hereto, which form an integral part of the disclosure of this provisional patent application. It should be understood that all examples and illustrations in Appendices A and B are purely illustrative, and not intended to be limiting.

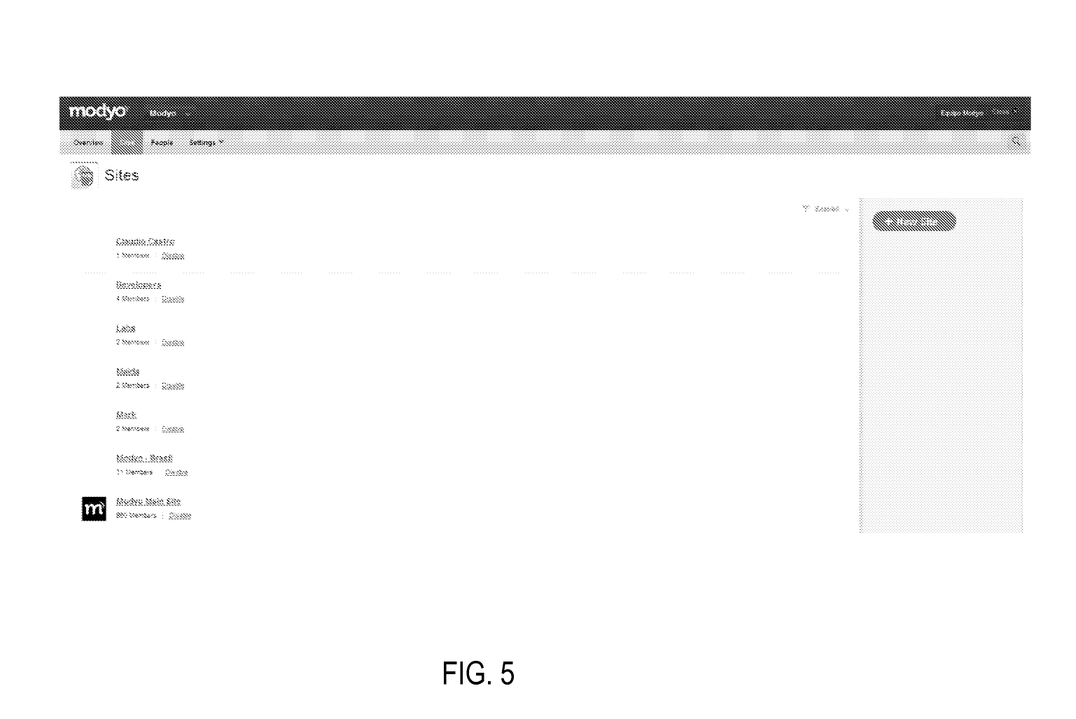

FIG. 4 illustrates an embodiment of a user interface whereby a user logs into the platform, for example, for the purpose of designing one or more sites within the platform. In an embodiment, once the user is logged into the platform, the user can display a user interface for creating a new site as shown in FIG. 5. In an embodiment, the user begins the process of creating a new site by selecting the user interface control “+New Site”. The user then supplies various basic information for the site such as, for example, a name and a base template for the site (not shown).

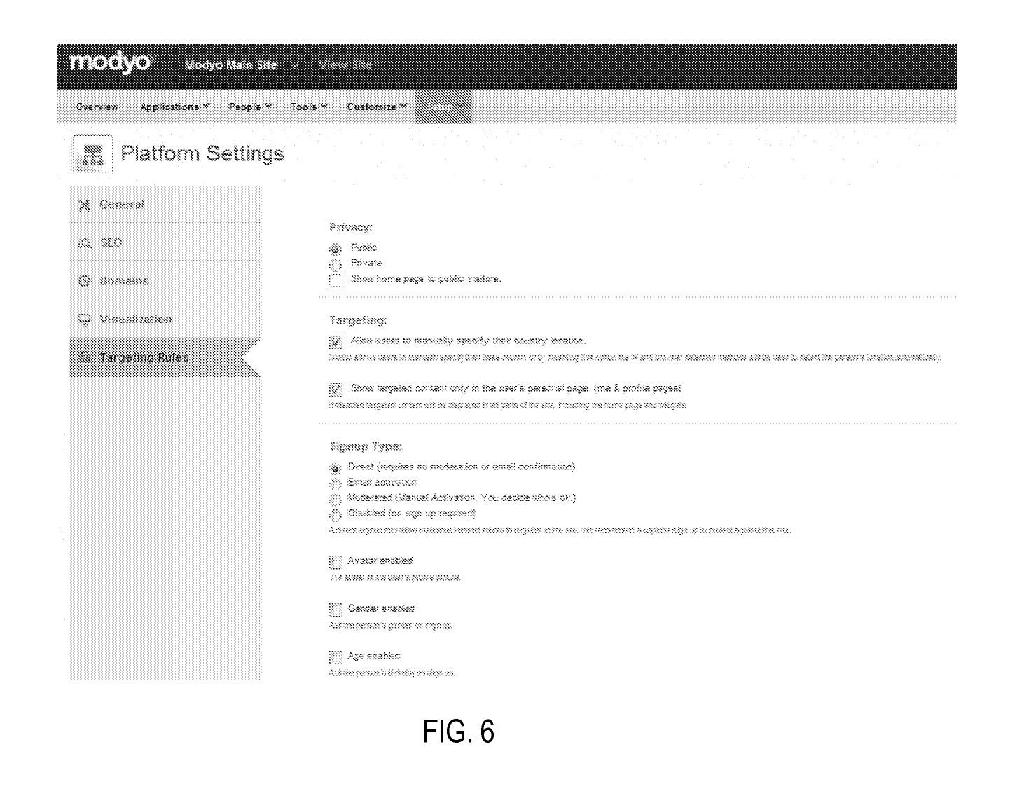

Once a new site is created, the site can be targeted to user-defined targets. FIG. 6 illustrates an embodiment of a user interface for defining initial target restrictions, for example, restrictions to restrict targeting to a specific personal profile page or the entire web site. Restrictions can further provide, for example, privacy options, permission for users to disable IP targeting, signup types (e.g. direct or moderated), permission for user to use avatars in their respective profiles, and requiring disclosure of age and/or gender on signup. Restrictions can also determines whether the site will be “social” or for content and sign up only.

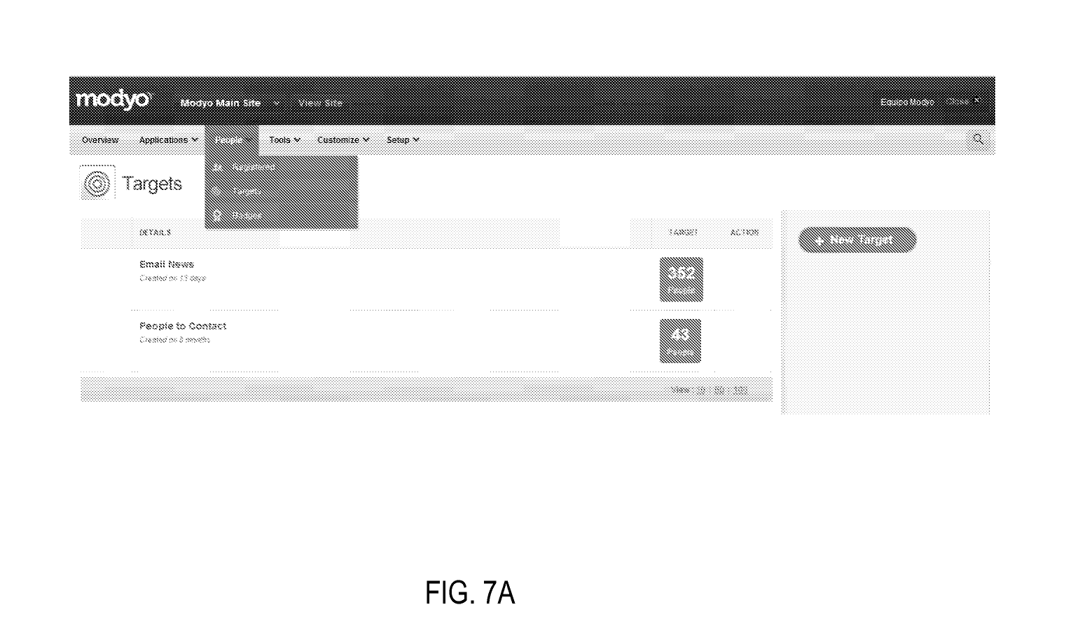

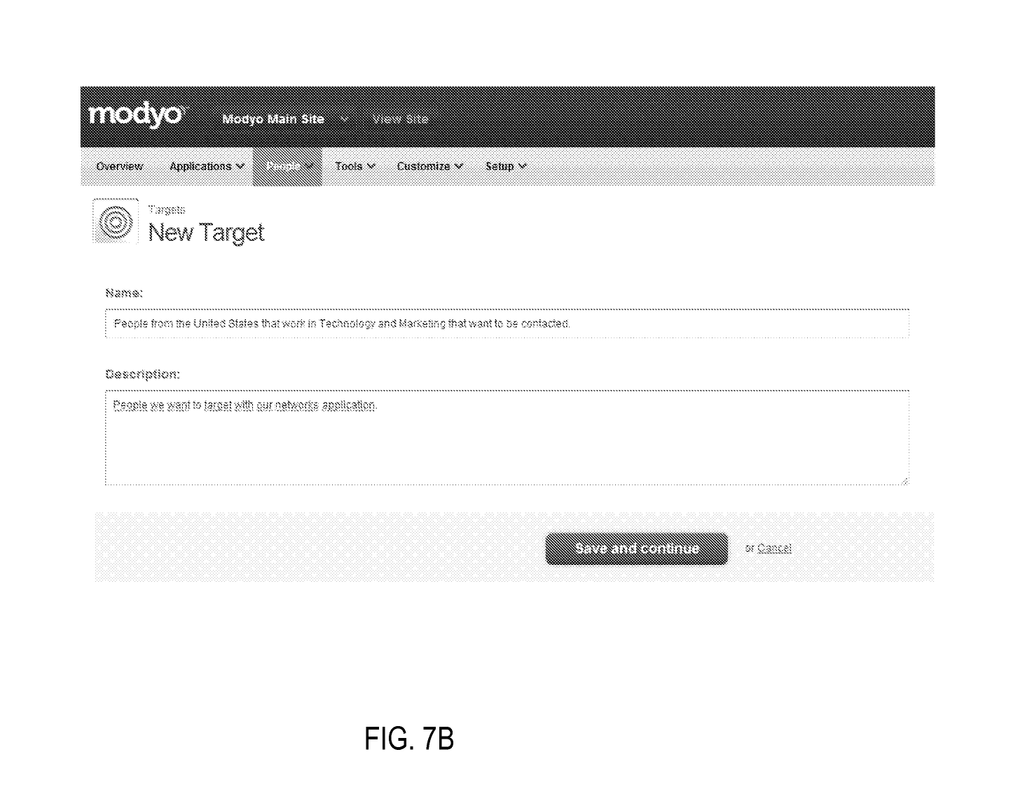

After defining initial targeting restrictions, targets can be defined for the site. FIGS. 7A and B illustrate an embodiment of a user interface for defining a target at a site level such as, for example, persons that:
Live in the United States.
Work in technology.
Want to be contacted.
   Such a group could, for example, represent people a technology provider wants to target with a network application.

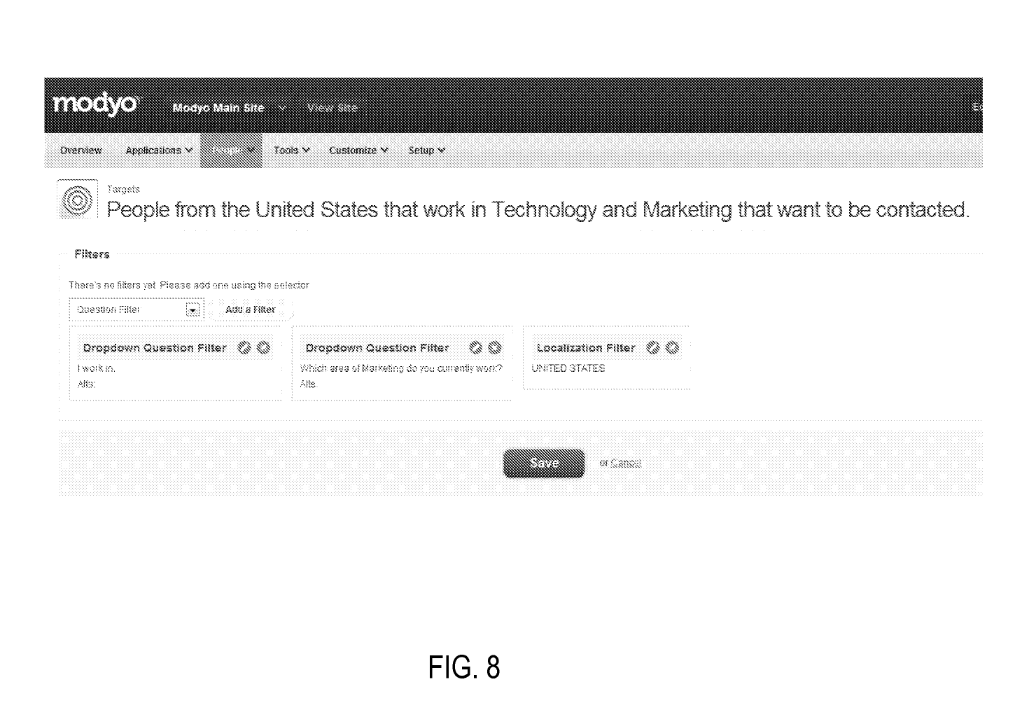

Targets can be refined using various types of filtering. FIG. 8 illustrates an embodiment of a user interface for applying a filter to a target. One or many filters can be applied to create a specific target. In various embodiments, filters could include, for example:
A basic profile filter that enables targeting of people based on their age, sex and initial registration information.
A comment filter that enables targeting of people based on the number comments relating to such persons.
A friend filter that enables targeting of people based on the number of friends or contacts they have in a site.
An interactions filter that enables targeting of people based on the number of interactions or submissions in an application.
An invitations filter that enables targeting of people based on the number of invitations that someone has sent to other people to join a site.
A localization filter enables targeting of people based on the geographic location of a person.
An opinion filter that enables targeting of people based on their likes or dislikes related to content or submissions by others.
A people filter that enables specific people to be added to a target based on their name.
A question filter that enables targeting of people based on data submitted in forms.
A social applications filter that enables targeting of people based on their social network that they connected to the site.
A vote filter that enables targeting of people based on the number of votes related to applications or other people's submissions.

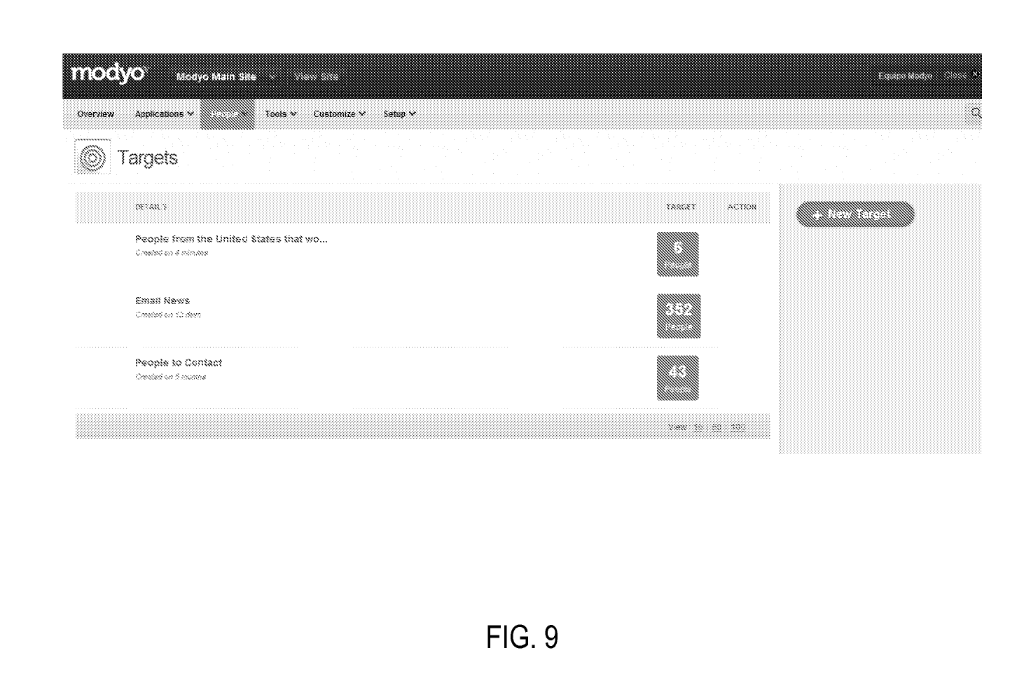

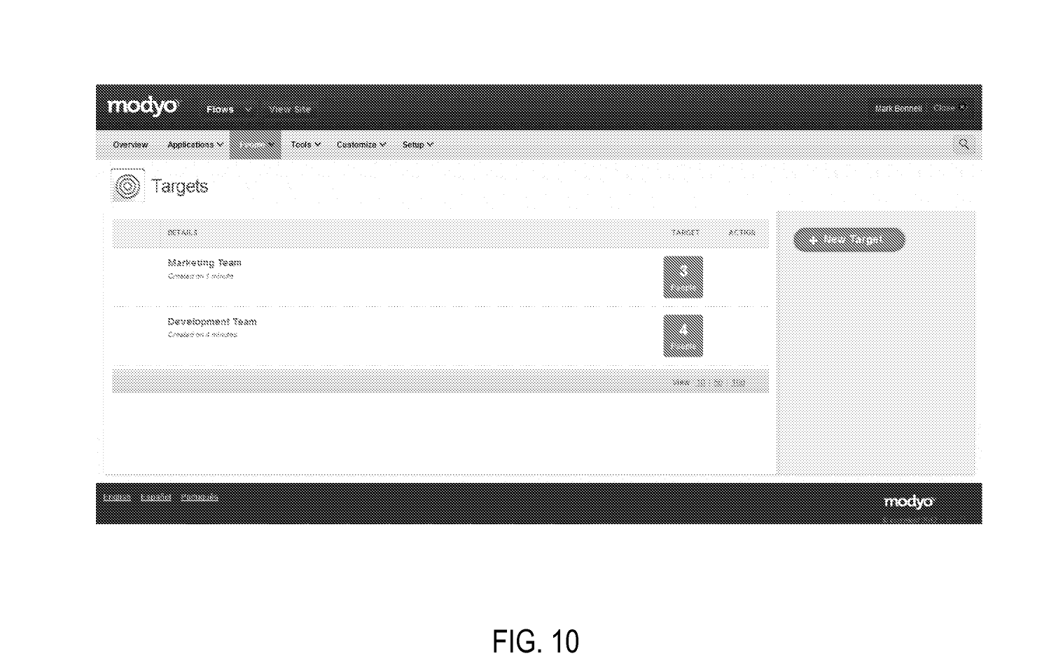

After the target is defined and filtering criteria are applied, users can be grouped into the target. FIG. 9 illustrates an embodiment of a user interface showing a summary of the users that match the target criteria that are grouped into a target. As shown in FIG. 10, the targeting process can be repeated without restriction identifying matches to the target at any time.

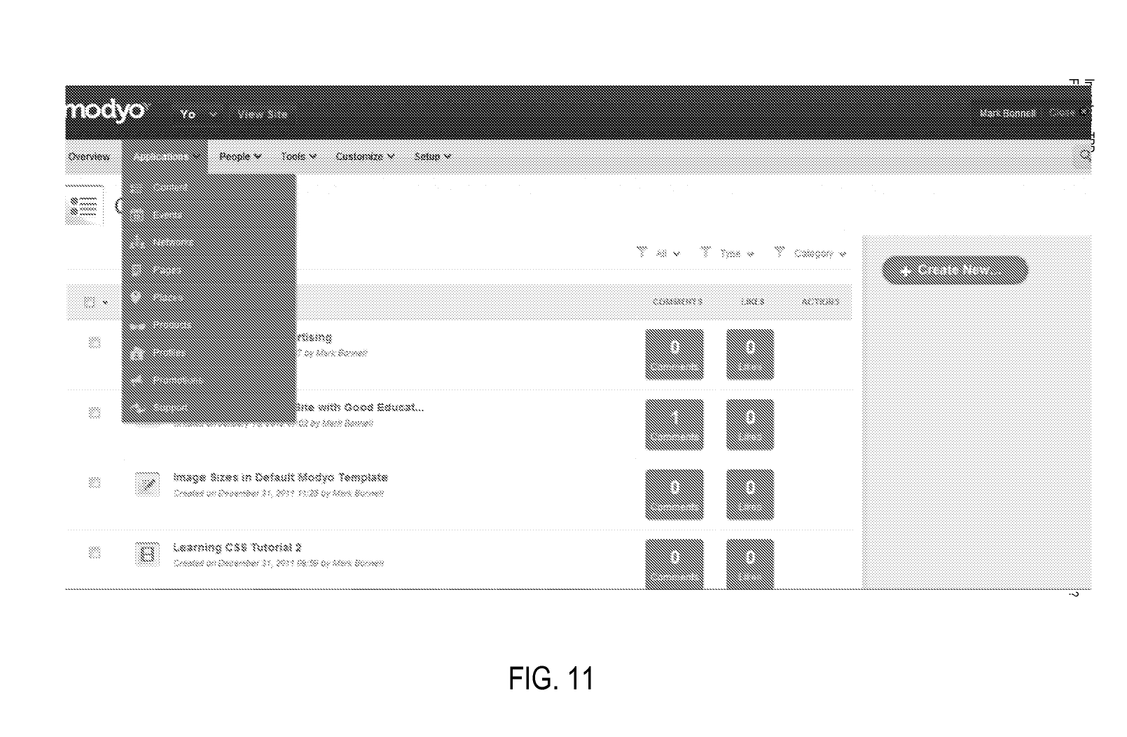

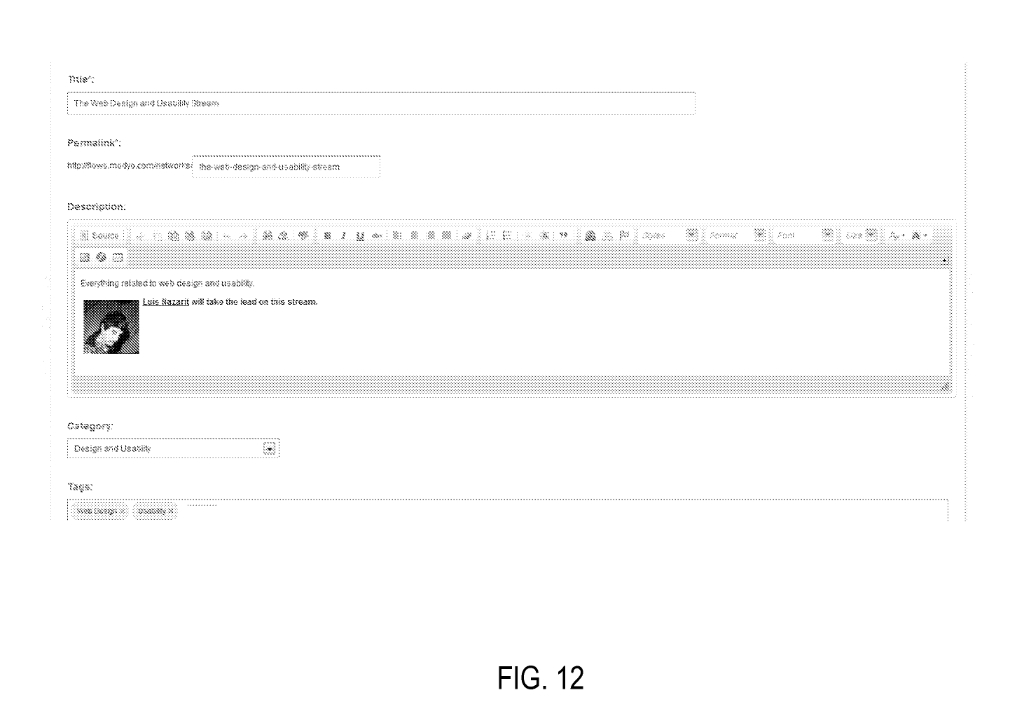

One the target has been created, multiple applications can be targeted to specific targets. FIG. 11 illustrates an embodiment of a user interface that allows a user to select applications for targeting via a pull-down menu. Such applications can include, for example, content, events, networks, pages, places, products, profiles, promotions and support. In an embodiment:
Content is the platform's CMS (content management system) that allows the addition of any type of content (posts, videos, audio, albums, files)
Events allow the publication of events and target events to specific people and audiences who can confirm their attendance to the event.
Networks enable people to share things in a stream. People with access to the networks can share pictures, videos, posts, links, and places. For example, an embodiment of the network application is shown in FIG. 12, which generates a collaboration stream
Pages are individual web pages that can be created and place anywhere in a site.
Places enable the addition of specific places to a site (e.g. stores or locations being promoted).
Products providing feature rich product pages in unique views where people can post reviews and interact with products.
Profiles feature things such as people or things in unique ways so people can interact, become fans or view related media.
Promotions that target specific promotions to specific people, for example, a specific coupon presented to a specific audience.
Support provides an application for managing questions, problems and ideas that you channeled into a logical workflow based on specific categories, products or issues.

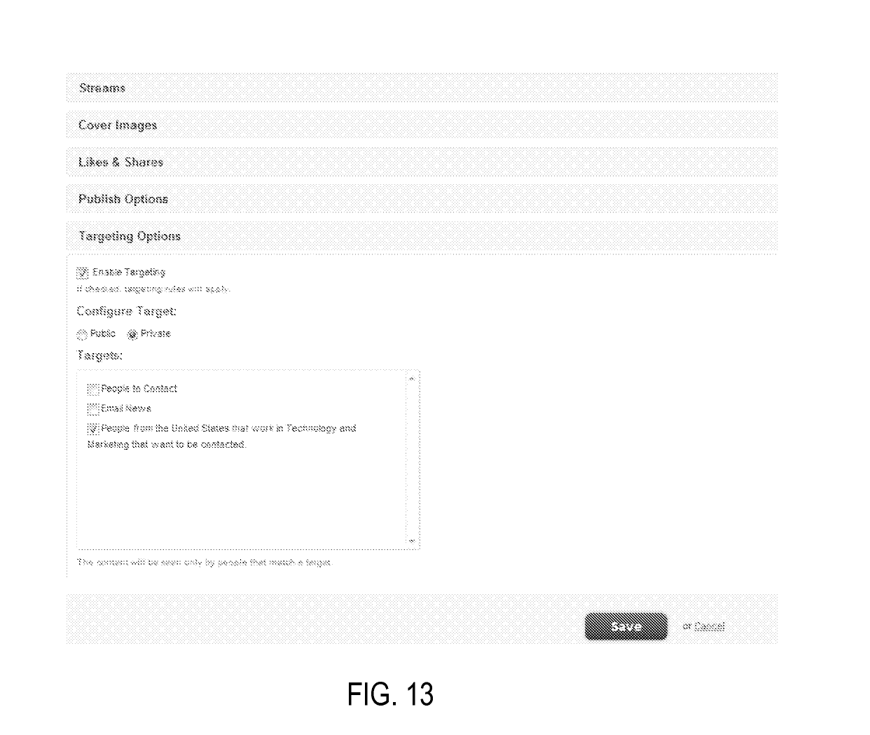

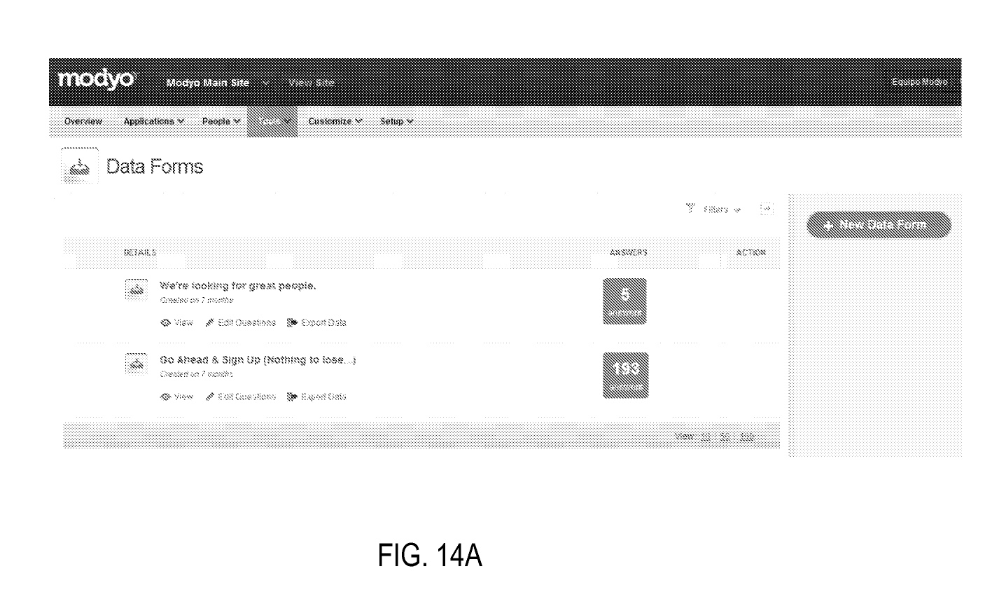

FIG. 13 illustrates an embodiment of a user interface that enables a user to specify targeting options for an application. Such options could include, for example, an identification of one or more targets and an indication as to whether the application is only visible to targets (e.g. “private”).

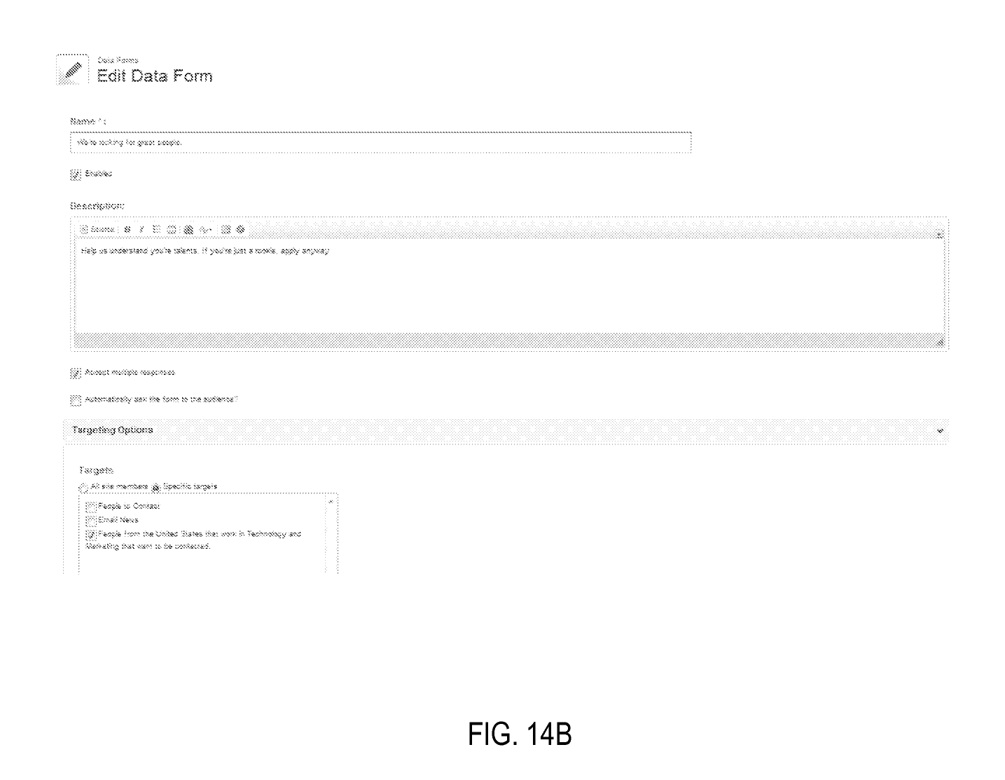

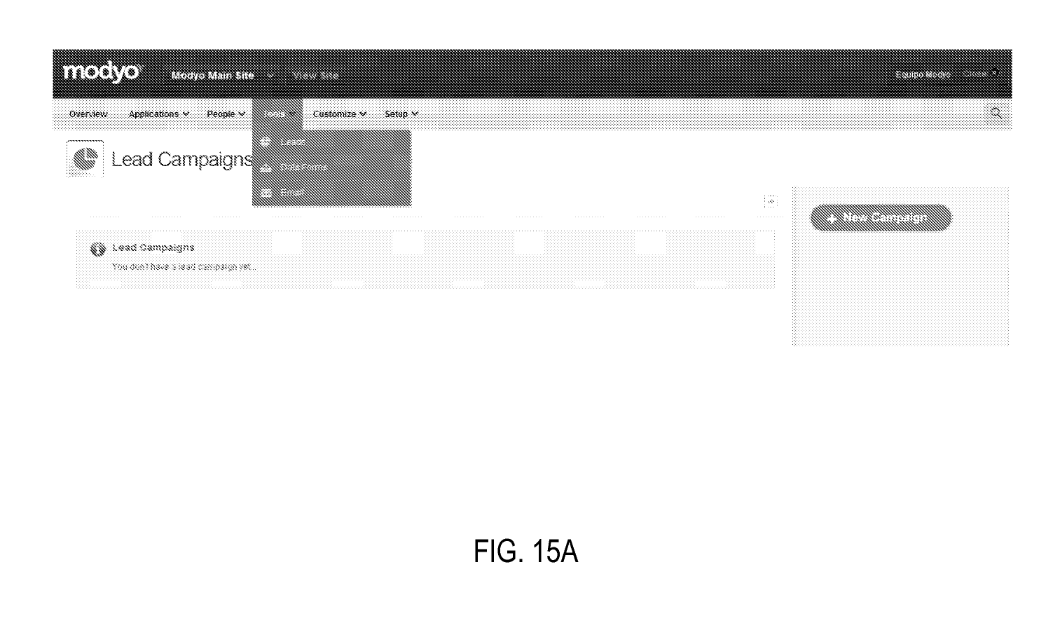

In various embodiments, in addition to targeting applications to targets, registration forms can be dynamically created, matched and made available to specific targets on the fly. FIG. 14A illustrates an embodiment of a user interface that enables a user to create data forms that can be presented to targets to gather additional data about such targets. FIG. 14B illustrates an embodiment of a user interface that enables a user to edit and refine a new or existing data form, as well as specify targets for the data form. In the illustrated embodiment, only that work in technology or marketing will interact with the data form.

In an embodiment, a URL can be generated to track people that fall into the target from a third party web site. One purpose of such a URL is to determine which advertising or URL's generate people that register and fall into a specfic target. FIG. 15A illustrates an embodiment of a user interface to begin creation of a leads campaign. FIG. 15B illustrates an embodiment of a user interface where further details relating to the leads campaign are specified.

### An Illustrative Cloud Computing Environment

In an embodiment, the platform is implemented within a cloud-computing environment provided by a third-party service provider, for example, the AMAZON WEB SERVICES (AWS) cloud-computing environment.

In an embodiment, the platform is distributed among different virtual servers organized into clusters, each cluster with a specific purpose and security policies. The application servers contain the application logic and can be are accessed through, for example, a service such as the AMAZON ELASTIC LOAD BALANCER (ELB), which optimizes server resources.

In an embodiment, content which is uploaded from users and clients are stored within the cloud-computing environment, for example, using AMAZON S3. In an embodiment, database cluster contains all data referenced from the platform. In an embodiment, the database provides support services, for example:
Caching: which reduces direct database processing and allows for a fast response to complex queries and objects used in application servers. In one embodiment, the technology used is MEMCACHED, which is a free, open source, high-performance and distributed memory object caching system.
Indexing: which enables faster and more efficient queries on data hosted within the platform's database servers. In an embodiment, the service is provided by SOLR, an open-source search server based on the LUCENE JAVA search library.
Localization: which enables the platform to obtain localization information from a user IP. In various embodiments, using reverse search, the platform can obtain the city, region, country and other local information from any visitor. In an embodiment, the IP database is updated and provided by IP2LOCATION.
Queue Service: in various embodiments, the platform user background processes. In an embodiment, when a task needs to be completed, it is added to a queue system to be processed when possible. In an embodiment, the technology used is ACTIVEMQ, which is an open source message broker that implements the JAVA MESSAGING SERVICE. In an embodiment, ACTIVEMQ runs on top of TOMCAT application servers.
Video Processing: which converts videos to standard portable formats and qualities.
Image Processing: processes images to transform the images into standard sizes.

In an embodiment, the servers in the platform use the DEBIAN6 (Squeeze) 64-bit operating system which is based on LINUX. In an embodiment, every server can be categorized into various roles, for example:
Application Servers: which, in various embodiments, run the main platform applications. In an embodiment, the application servers are configured to use a RUBY ON RAILS environment comprising RUBY ENTERPRISE EDITION (REE), PHUSION PASSENGER and NGINX servers.
Database Servers: which, in various embodiments, host the platform's databases using, for example, XTRADB, a MYSQL modification provided by PERCONA.
Utility Servers: which, in various embodiments, provide a set of support services, for example, location services, cache, message queue and indexing.

In an embodiment, the platform and its corresponding apps run from AMAZON AWS that provides SAS70 Type II2\ certification, which guarantees adequate control, and operational efficiency of data center infrastructure. In an embodiment, all data is stored redundantly in multiple physical locations, providing high availability. In an embodiment, the platform follows AMAZON approved configurations to protect against security threats on data networks, including the following types of attacks:
DDoS (Distributed Denial Of Service)
MITM (Man In the Middle)
IP Spoofing
Port Scanning

In an embodiment, the platform utilizes a backup strategy consists in doing frequent daily full binary backup and a daily dump in an SQL text file. In an embodiment, the binary backup is performed using XTRABACKUP, a non-blocking binary backup software to MYSQL and XTRADB databases. In an embodiment, the dump backup is performed on a slave database, because it needs to block all tables to be consistent. In an embodiment, a slave database is maintained as an immediate backup of all data, cloning the master database in real time in the event of a database failure. The cloned database can be swapped for the master at any moment with no data loss.

In an embodiment, the platform utilizes a “shared nothing architecture.” A shared nothing architecture is a distributed computing architecture that consists of multiple nodes such that each node has its own private memory, disks and input/output devices independent of any other node in the network. Each node is self-sufficient and shares nothing across the network. Therefore, there are no points of contention across the system and no scope for data sharing or system resources. Systems can scale almost indefinitely simply by adding nodes in the form of inexpensive computers, since there is no single bottleneck to slow the system down.

In an embodiment, the platform allows users to customize the code of the front-end via standard technologies like JAVASCRIPT and HTML in combination with the platform template language that is used to provide a dynamic runtime to the static web and mobile pages.

FIG. 16 shows a block diagram of a data processing system that can be used in various embodiments of the disclosed systems and methods. While FIG. 16 illustrates various components of a computer system, it is not intended to represent any particular architecture or manner of interconnecting the components. Other systems that have fewer or more components may also be used.

In FIG. 16, the system 1601 includes an inter-connect 1602 (e.g., bus and system core logic), which interconnects a microprocessor(s) 1603 and memory 1608. The microprocessor 1603 is coupled to cache memory 1604 in the example of FIG. 16.

The inter-connect 1602 interconnects the microprocessor(s) 1603 and the memory 1608 together and also interconnects them to a display controller and display device 1607 and to peripheral devices such as input/output (I/O) devices 1605 through an input/output controller(s) 1606. Typical I/O devices include mice, keyboards, modems, network interfaces, printers, scanners, video cameras and other devices that are well known in the art.

The inter-connect 1602 may include one or more buses connected to one another through various bridges, controllers and/or adapters. In one embodiment the I/O controller 1606 includes a USB (Universal Serial Bus) adapter for controlling USB peripherals, and/or an IEEE-1394 bus adapter for controlling IEEE-1394 peripherals.

The memory 1608 may include ROM (Read-Only Memory), and volatile RAM (Random Access Memory) and non-volatile memory, such as hard drive, flash memory, etc.

Volatile RAM is typically implemented as dynamic RAM (DRAM) that requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In an embodiment, the various servers supporting the platform are implemented using one or more data processing systems as illustrated in FIG. 16. In an embodiment, user devices such as those used to access the user interfaces shown in FIGS. 4-15 and Appendices A and B are implemented using one or more data processing system as illustrated in FIG. 16.

In some embodiments, one or more servers of the system illustrated in FIG. 16 are replaced with the service of a peer-to-peer network or a cloud configuration of a plurality of data processing systems, or a network of distributed computing systems. The peer-to-peer network, or cloud based server system, can be collectively viewed as a server data processing system.

Embodiments of the disclosure can be implemented via the microprocessor(s) 1603 and/or the memory 1608. For example, the functionalities described above can be partially implemented via hardware logic in the microprocessor(s) 1603 and partially using the instructions stored in the memory 1608. Some embodiments are implemented using the microprocessor(s) 1603 without additional instructions stored in the memory 1608. Some embodiments are implemented using the instructions stored in the memory 1608 for execution by one or more general-purpose microprocessor(s) 1603. Thus, the disclosure is not limited to a specific configuration of hardware and/or software.

FIG. 17 shows a block diagram of a user device. In FIG. 17, the user device includes an inter-connect 1721 connecting a communication device 1723, such as a network interface device, a presentation device 1729, such as a display screen, a user input device 1731, such as a keyboard or touch screen, user applications 1725 implemented as hardware, software, firmware or a combination of any of such media, such various user applications (e.g. apps), a memory 1727, such as RAM or magnetic storage, and a processor 1733 that, inter alia, executes the user applications 1725.

In one embodiment, the user applications implement one or more user interfaces displayed on the presentation device 1729 that provides users the capabilities to, for example, access the Internet, and display and interact with user interfaces provided by the platform, such as, for example the user interfaces shown in FIGS. 4-15 and Appendices A and B. In one embodiment, the user applications use the communication device to communicate with meeting coordination servers such as that shown in 372 of FIG. 3.

In one embodiment, users use the user input device 1731 to interacts with the device via the user applications 1725 supported by the device, for example, by proposing and accepting invitations for meeting between users, as described in detail above with respect to FIGS. 1 and 2. The user input device 1731 may include a text input device, a still image camera, a video camera, and/or a sound recorder, etc.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations, which are not order dependent, may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A method of facilitating the targeting of software as a service applications to specific global audiences in real time, comprising:
providing a system that allows users to configure and deploy multiple integrated web sites and mobile sites with applications that are served in real time by specifying which target consumers qualify to interact with specific applications in real time across multiple integrated web sites, the system providing said users with the ability to create via a web browser a cluster of integrated web sites, mobile sites, and applications on behalf of an organization in its own private cloud where applications, web sites, mobile sites and users can be matched through a consumer targeting engine based on dynamic filters with relevant content and applications in real time across the cluster of web sites and mobile sites.

2. The method of claim 1, further comprising providing the user with the ability to define via a web browser unique data conditions that match applications with target users via a web site or mobile site.

3. The method of claim 1, wherein user data collected from online data forms is matched with user data collected from interactions within a web site to produce dynamic targets.

4. The method of claim 3, wherein said dynamic targets form the foundation of a targeting engine for matching relevant content and applications to specific audiences within a web site or cluster of web sites.
